(19) United States
(12) Patent Application Publication
(10) Pub. No.: US 2012/0229642 A1
(43) Pub. Date: Sep. 13, 2012

(54) VEHICLE MONITORING SYSTEM

(75) Inventor: Casey A. KILMER, Nashville, TN (US)

(73) Assignee: Nissan North America, Inc., Franklin, TN (US)

(21) Appl. No.: 13/045,248

(22) Filed: Mar. 10, 2011

(51) Int. Cl. H04N 7/18; G08G 1/0962

(52) U.S. Cl. 348/148; 340/901; 348/E07.085

(57) ABSTRACT

A vehicle monitoring system comprises a detection device, a display and a controller. The detection device is coupled to a vehicle and configured to capture information relating to an area proximal to the vehicle. The display includes a display area that is configured to provide the information captured by the detection device to a user of the vehicle. The controller is configured to control the display to provide the information on a first portion of the display area that is less than an entirety of the display area in response to a first vehicle condition, and to provide the information on a second portion of the display area, greater than the first portion, in response to a second vehicle condition.

### BACKGROUND OF THE INVENTION

1. Field of the Invention

The present invention relates to a vehicle monitoring system. More particularly, the present invention relates to a vehicle monitoring system that is configured to display differently formatted images, which pertain to an area proximal to a vehicle, based on different detected vehicle conditions.

2. Background Information

A vehicle, such as a car, van, sport utility vehicle, and the like can be equipped with a vehicle monitoring system. A vehicle monitoring system can include rear-view monitors, around-view monitors, interior monitors, and external object detection monitors as understood in the art. Typically, each of the monitors includes a detection device, such as a camera or proximity sensor, that is positioned on the vehicle. The detection device provides information to a display, such as a video display that is positioned within the vehicle. The display can be located, for example, on the instrument panel, as an overhead display, or at any other suitable location within the passenger compartment of the vehicle. Therefore, the monitoring system enables the driver or a passenger to view or detect objects in an area internal or external to the vehicle, such as in an area behind the rear bumper of the vehicle, that is not readily viewable from driver's seat.

The monitoring systems are typically activated based on an operation that is performed by the driver or a passenger of the vehicle (e.g., a user of the vehicle) and is closely associated with the monitoring system. The operation can include, for example, placing the vehicle transmission in reverse. Also, the operation can include pressing a designated button to activate the monitoring system, such as an around-view monitoring system. An around-view system can be particularly helpful to a driver when the vehicle is entering a garage or other location in which the vehicle typically will have limited maneuverability.

As understood in the art, these systems often inherently include a delay period between the time that the user (e.g., the driver) performs the operation and the time that the display displays the information provided by the monitoring system. Hence, the effectiveness of the monitoring system is reduced during this delay period until the display becomes fully operational. Additionally, a driver often does not perform the operation which activates the monitoring system for a sufficient period of time before starting to move the vehicle. For instance, the driver may not perform the operation before shifting the vehicle transmission into reverse. This failure to perform the operation thus further reduces the effectiveness of the monitoring system because the display does not display the image provided by the monitoring system for a sufficient time before the movement of the vehicle occurs. Accordingly, the vehicle may already be moving by the time the display begins to display the image.

### SUMMARY

In view of the state of the known technology, one aspect of the present invention provides a vehicle monitoring system comprising a detection device, a display and a controller. The detection device is coupled to a vehicle and configured to capture information relating to an area proximal to the vehicle. The display includes a display area that is configured to provide the information captured by the detection device to a user of the vehicle. The controller is configured to control the display to provide the information on a first portion of the display area that is less than an entirety of the display area in response to a first vehicle condition, and to provide the information on a second portion of the display area, greater than the first portion, in response to a second vehicle condition.

### BRIEF DESCRIPTION OF THE DRAWINGS

Referring now to the attached drawings which form a part of this original disclosure:

FIG. 1 is a schematic diagram of a vehicle monitoring system in a vehicle according to a disclosed embodiment;

FIG. 2 is a schematic diagram illustrating a region directly rearward of the vehicle, a region directly forward of the vehicle, and regions laterally to the right and left of the vehicle that can be viewed using the vehicle monitoring system;

FIG. 3 is a schematic diagram of an example of the passenger compartment and instrument panel of the vehicle;

FIG. 4 is a flowchart showing an example of operations performed by the vehicle monitoring system;

FIG. 5 is an example of a display that is being controlled by the vehicle monitoring system to display preview information;

FIG. 6 is an example of the display that is being controlled by the vehicle monitoring system to display monitoring information; and

FIG. 7 is an example of the display that is being controlled by the vehicle monitoring system to display vehicle information.

### DETAILED DESCRIPTION OF EMBODIMENTS

Selected embodiments of the present invention will now be explained with reference to the drawings. It will be apparent to those skilled in the art from this disclosure that the following descriptions of the embodiments are provided for illustration only and not for the purpose of limiting the invention as defined by the appended claims and their equivalents.

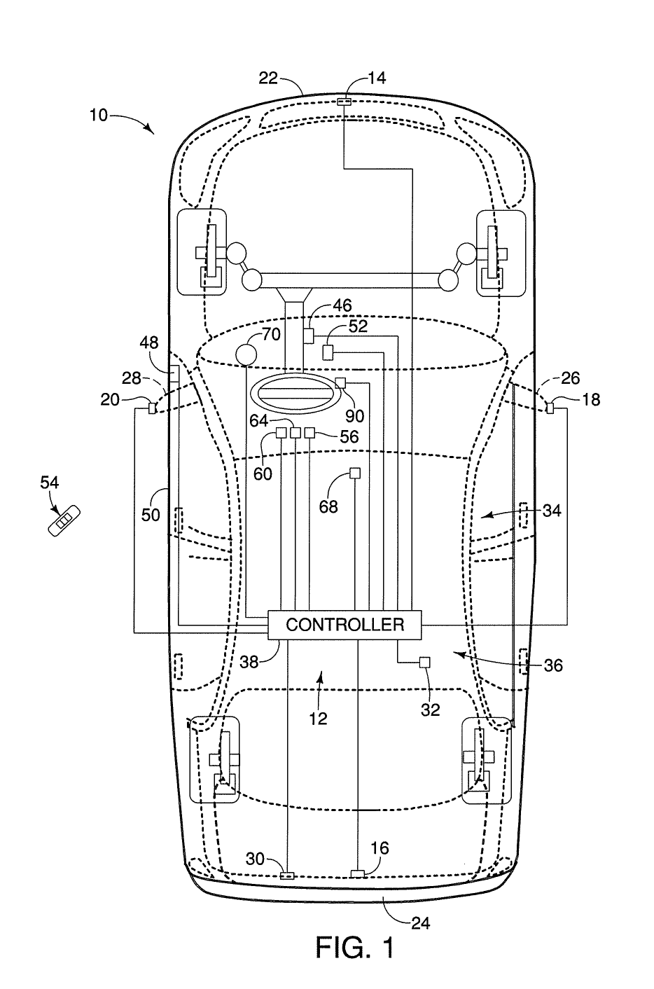

Referring to FIG. 1, a vehicle 10, such as a car, van, sport utility vehicle, and the like, includes a vehicle monitoring system 12 according to a disclosed embodiment. In this example, the vehicle 10 is equipped with a plurality of onboard cameras including a front video camera 14, a rear video camera 16, a right side video camera 18 and a left side video camera 20. The front camera 14 can be installed on a frontward portion of the vehicle 10, such as at or near the front bumper 22 or grille of the vehicle 10. The rear camera 16 can be installed on a rearward portion of the vehicle 10, such as at or near the rear bumper 24 of the vehicle 10. The right side camera 18 can be installed on a right lateral portion of the vehicle 10, such as at or near a right side view mirror 26. The left side camera 20 can be installed on a left lateral portion of the vehicle 10, such as at or near the left side view mirror 28.

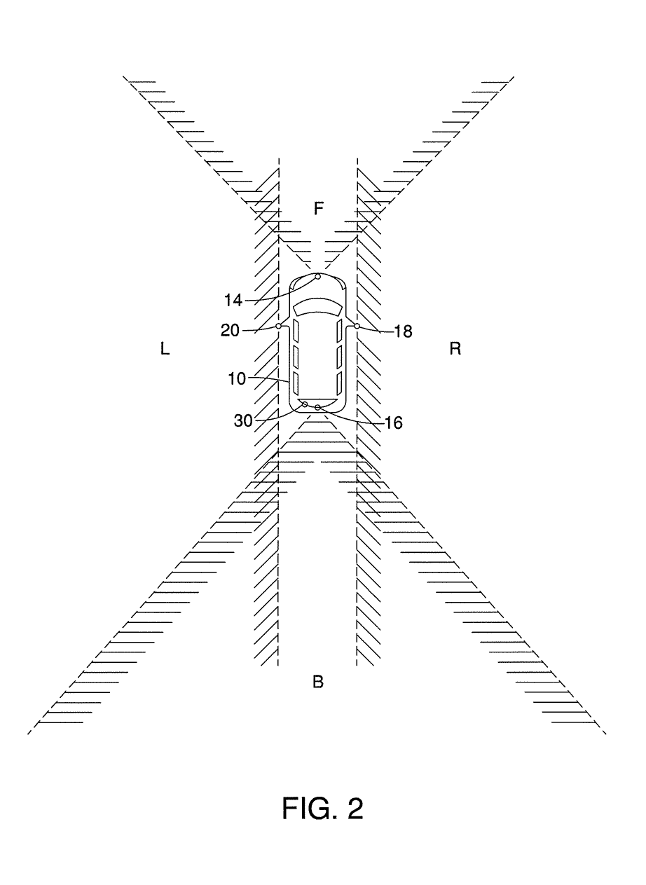

The front camera 14, the rear camera 16, the right side camera 18 and the left side camera 20 are arranged to capture images of a region directly forward and rearward of the vehicle 10, and images of regions laterally of the host vehicle 10. For example, as shown in FIG. 2, the front camera 14 captures images in the region F in front of the vehicle 10, and the rear camera 16 captures images in the region B to the back or rear of the vehicle 10. The right side camera 18 captures images in the region R to the right of the vehicle 10, and the left side camera 20 captures images in the region L to the left of the vehicle 10. Accordingly, the front camera 14, the rear camera 16, the right side camera 18 and the left side camera 20 collectively function as an around-view image capturing system for the vehicle 10 as understood in the art. In addition, at least one proximity sensor 30 is mounted to the vehicle 10. The proximity sensor 30 is configured to detect an object external to the vehicle 10 and provide information pertaining to the detected object as the information. As understood in the art, the proximity sensor 30 can use, for example, a camera, sonar detection, infrared detection or any other suitable type of detector to detect the object.

As further shown, the vehicle 10 includes at least one interior video camera 32 that is configured to capture images of a portion of the passenger compartment 34 of the vehicle 10, such as the rear seat area 36. Naturally, the vehicle 10 can include any suitable number of cameras for capturing an around-view image proximal to the exterior of the vehicle 10 and an image of the portion of the passenger compartment 34. For purposes of this discussion, any or all of the front camera 14, the rear camera 16, the right side camera 18, the left side camera 20, the proximity sensor 30 and the interior camera 32 can be construed as a detection device that is coupled to the vehicle 10 and configured to capture information relating to an area proximal to the vehicle 10.

The vehicle monitoring system 12 further includes a controller 38. As understood by one skilled in the art, the controller 38 preferably includes a microcomputer with a control program that controls the vehicle monitoring system 12 as discussed herein. The controller 38 can also include other conventional components such as an input interface circuit, an output interface circuit, and storage devices such as a ROM (Read Only Memory) device and a RAM (Random Access Memory) device. The RAM and ROM store processing results and control programs that are run by the controller 38. The controller 38 is operatively coupled to the components of the vehicle monitoring system 12, and to the components of the vehicle 10 as appropriate, in a conventional manner. It will be apparent to those skilled in the art from this disclosure that the precise structure and algorithms for the controller 38 can be any combination of hardware and software that will carry out the functions of the embodiments discussed herein.

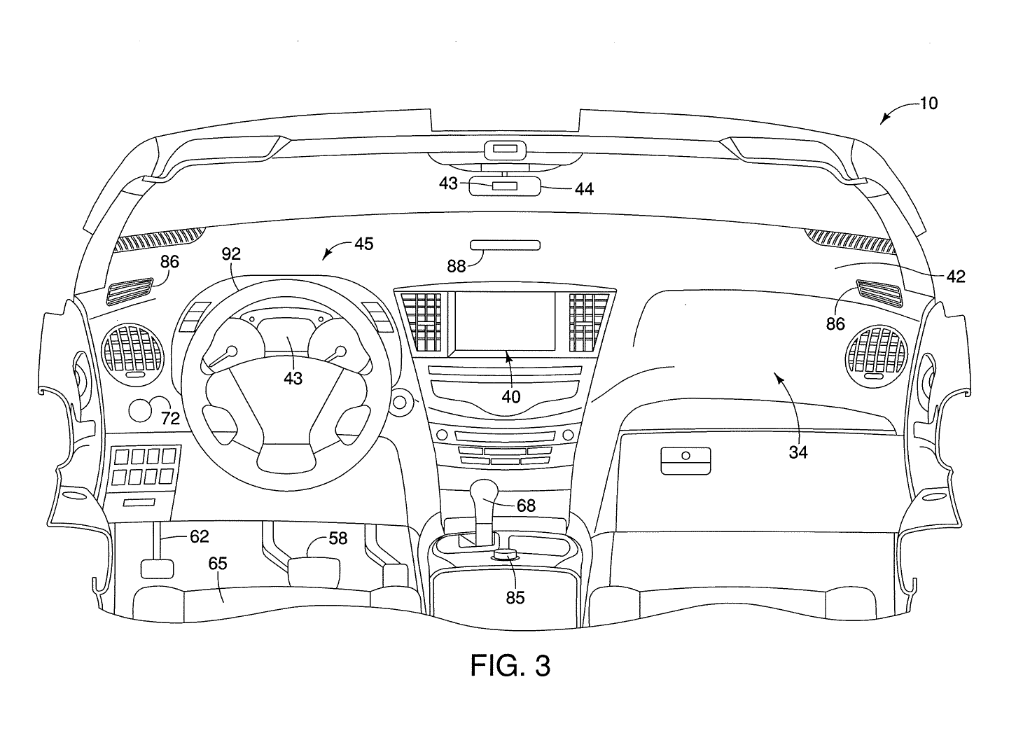

The controller 38 receives the video images captured by the front camera 14, the rear camera 16, the right side camera 18, the left side camera 20 and the interior camera 32, and the information captured by the proximity sensor 30. In addition, the controller 38 communicates with a display 40 that is positioned in the passenger compartment 34 as shown, for example, in FIG. 3. The display 40 can be located, for example, on the instrument panel 42, as an overhead display, or at any other suitable location within the passenger compartment 34 of the vehicle 10. The display 40 can be the display that is configured for use by the navigation system of the vehicle 10 as a navigation display which displays navigation information as understood in the art. Additionally, the controller 38 can communicate with a display 43 that is separate from the navigation display 40 disposed within the vehicle 10. This other display 43 can be, for example, in the rear view mirror 44 as shown. Alternatively or in addition, the other display 43 can be in the meter cluster 45, a heads up display, a separate center stack display or on rear monitors traditionally used for rear seat entertainment.

Accordingly, the controller 38 controls the display 40, the display 43, or both, to display information captured by the front camera 14, the rear camera 16, the right side camera 18, the left side camera 20 and the interior camera 30 as discussed in more detail below. For purposes of this discussion, the display 40, the display 43 or both can be construed as a display that is disposed within the vehicle 10 and configured to provide the information captured by the detection device to the user, such as a driver of the vehicle 10.

As further shown in FIG. 1, the vehicle 10 includes a plurality of sensors that are configured to detect conditions of the vehicle 10. For example, the vehicle 10 includes an ignition sensor 46 that detects starting of the ignition of the vehicle 10. The vehicle 10 also includes a door sensor 48 that detects the closing or locking of a door 50 of the vehicle 10, such as the door 50 on the front driver side of the vehicle 10. The vehicle 10 further includes a key sensor 52 that can sense when a key 54, such as a smart key fob, is present within the vehicle 10. That is, the key sensor 52 can be configured to provide ranging signals to the controller 38 which can estimate the location of the key 54 with respect to the vehicle 10 in a manner as understood in the art. Also, the key sensor 52 can include a tactile sensor that can be contacted by the key 54. In addition, the vehicle 10 can include a brake sensor 56 that senses when the brake pedal 58 of the vehicle 10 is depressed. Furthermore, a vehicle 10 having a manual transmission can include a clutch sensor 60 that senses when a clutch pedal 62 of the vehicle 10 is depressed. The vehicle 10 can include any other suitable type of sensor, such as a tactile sensor 64 in the driver's seat 65 of the vehicle 10, that can sense when a driver is present in the vehicle 10. For purposes of this discussion, any or all of the ignition sensor 46, the door sensor 48, the key sensor 52, the brake sensor 56, the clutch sensor 60 and the tactile sensor 64 can be construed as a first sensor that is configured to detect a first vehicle condition relating to a user's presence, such as a driver's presence, within the vehicle 10.

The vehicle 10 can also include a transmission sensor 66 that senses when the transmission 68 of the vehicle 10 has been shifted, for example, from park to a motive gear (e.g., reverse or drive). The vehicle 10 can further include a button sensor 70 that senses when a button 72 is depressed to control an operation of the vehicle 10. For example, the button 72 can control the vehicle monitoring system 12 as discussed herein. The vehicle 10 can also include any other suitable type of sensor that can control the operation of the vehicle monitoring system 12 as discussed herein. For purposes of this discussion, any of the transmission sensor 66, the button sensor 70 and the other suitable sensors can be construed as a second sensor that is configured to detect a second vehicle condition relating to an operation of the vehicle 10.

As further shown in FIGS. 1 and 3, the controller 38 receives the signals provided by the ignition sensor 46, the door sensor 48, the key sensor 52, the brake sensor 56, the clutch sensor 60, the tactile sensor 64, the transmission sensor 66, the button sensor 70 and any other sensor in the vehicle 10. As will now be discussed, the controller 36 controls the operation of the vehicle monitoring system 12 based on the information received from the cameras and sensors mentioned above.

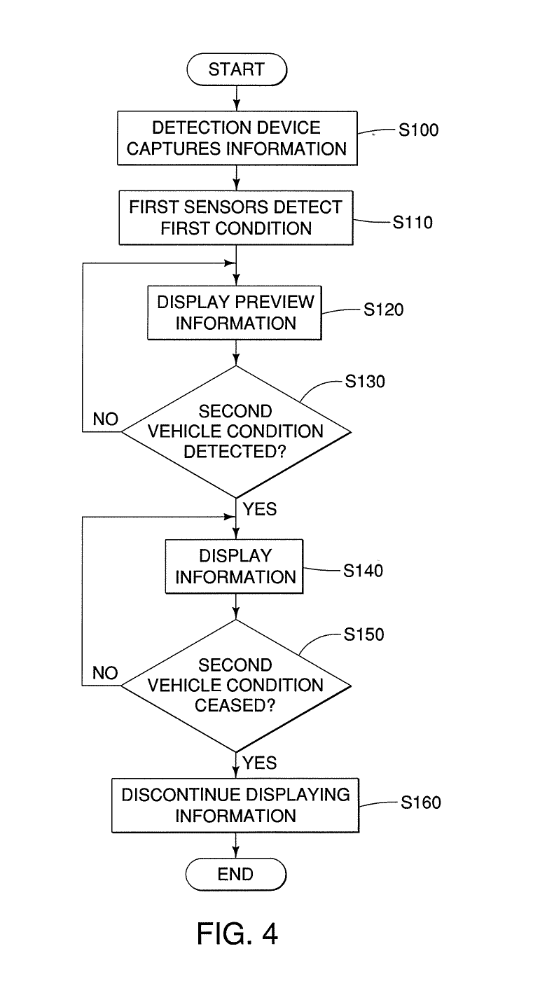

That is, as shown in the flowchart of FIG. 4, the detection device (e.g., any or all of the cameras and/or the proximity sensor discussed above) will capture information relating to an area proximal to the vehicle 10 in step S100 and provide the images to the controller 38. The information can be an image external to the vehicle 10, an image internal to the vehicle 10, or information pertaining to an object external to the vehicle. For instance, the cameras making up the detection device as discussed above can operate as a rear view monitor that is configured to capture an image rearward of the vehicle 10 as the information, or an around view monitor that is configured to capture an image surrounding the vehicle 10 as the information. The controller 38 can control the detection device to capture the information periodically while the vehicle 10 is turned off. This operation can occur in a manner similar to that in which an alarm system would function while the vehicle 10 is turned off Alternatively, the controller 38 can refrain from controlling the detection device from capturing any images until any of the first sensors mentioned above detect the presence of a user (e.g., a driver) in the vehicle 10.

In either event, any or all of the first sensors detect a first vehicle condition relating to a user's presence within the vehicle 10 in step S110 and provide signals pertaining to the first vehicle condition to the controller 38. Again, step S110 can be performed concurrently with step S100, before step S100, after step S100, or at all of these times with respect to step S100 where the detection device captures information relating to an area proximal to a vehicle 10.

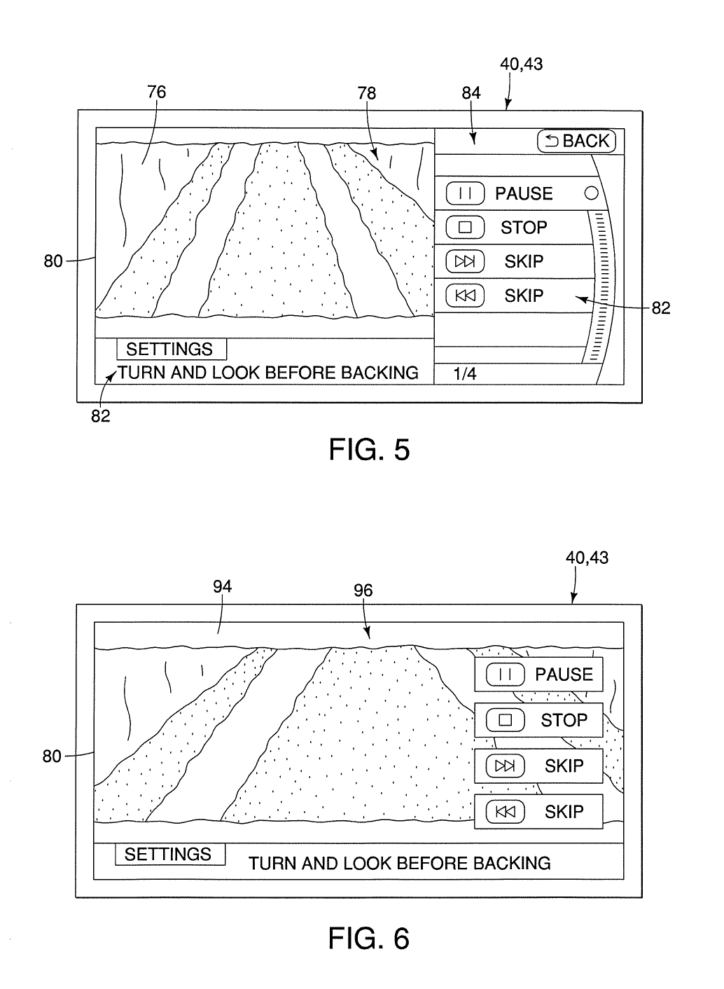

In step S120, the controller 38 controls a display, such as display 40, display 43, or both, to display the information provided by the detection device as preview information 76 in a first format when the first vehicle condition is detected. For example, as shown in FIG. 5, the controller 38 can control the display 40 and/or display 43 to provide the preview information 76 on a first portion 78 of the display area 80 that is less than an entirety of the display area 80 in response to the first vehicle condition. As discussed above, the first vehicle condition includes at least one of starting ignition of the vehicle 10, closing a door 50 of the vehicle 10, sensing of a vehicle key 54 within the vehicle 10, and depressing a brake 58 or clutch pedal 62 of the vehicle 10. The first portion 78 of the display area 80 could be, for example, at or about 50% of the display area 80, or any suitable amount of the display area, such as a range of 30% through 80% of the display area 80, or any other suitable amount that can provide an adequate preview of the captured information to the user. Also, other information 82 can be displayed on the first portion 78 of the display area 80 over the preview information 76, or in a second portion 84 of the display area 80. This other information 82 can include information such as radio information, DVD images and information, navigation information and so on.

Accordingly, the vehicle monitoring system 12 can, for example, provide the information as back seat views that show a preview of a baby or children in the back seat prior to the driver placing the transmission 68 into a motive gear. Also, by using multiple displays 40 and 43, the display 43, for example, can display the normal controls such as radio controls, navigation information and controls, HVAC and controls, and so on while the transmission 68 is in park. At the same time, the display 40 or another display can display information provided by the interior camera 32 to provide a preview image of a baby or children in the back seat that can be viewed by a passenger or the driver. The passenger or driver could also elect to turn off this display using, for example, controls 85 that instruct the controller 38 to discontinue displaying the preview information. For instance, the passenger can turn off the preview if the passenger wishes to watch a movie on the display 40 or control the radio using information on the display 40 while the vehicle 10 is in park. Furthermore, the controller 38 can control the multiple displays 40, 43 and so on to display different preview images. The displaying of different images can enable a user, such as the driver or a passenger, to view different areas, such as the rear seat, the area behind the vehicle 10, the area around the vehicle 10 and so on at the same time.

In addition, the controller 38 can control the vehicle monitoring system 12 to alert the user via an audible warning through car speakers 86, buzzer or a telltale light 88 (e.g., a red telltale light) if the detection device, such as the proximity sensor 30, detects motion behind or around the vehicle 10 (see FIG. 3). Also, the controller 38 can control the vehicle monitoring system 12 to operate a haptic feedback device 90 in, for example, the steering wheel 92 or seat 65 (see FIGS. 1 and 3) to warn driver of any motion behind or around the vehicle 10 as detected by the detection device.

In step S130, the controller 38 determines whether the second vehicle condition as discussed above has been detected. If the second vehicle condition has not been detected, the controller 38 continues to control the display 40 and/or the display 43 to provide the information on the first portion 78 of the display area 80. However, when user (e.g., the driver) performs an operation such as shifting the transmission 68 of the vehicle 10 from park to a motive gear (e.g., reverse or drive), pressing the button 72, or any other suitable operation, the second sensor, such as the transmission sensor 66 or button sensor 70, provides signals pertaining to the second vehicle condition to the controller 38. When the controller 38 detects the second vehicle condition in step S130, the controller 38 controls the display 40 and/or 44 that was displaying the first information to display the information in a second format, different from the first format, in step S140.

That is, as shown in FIG. 6, the controller 38 can control the display 40 and/or display 43 to display the information obtained by the detection device as monitoring information 94 on a larger portion 96 of the display area 80 in response to the second vehicle condition. The larger portion 96 of the display area 80 is greater than the first portion 78. For example, the larger portion 96 can be the entire display area 80 or approximately the entire display area 80. That is, if the first portion 78 is, for example, 50% of the display area 80, the larger portion 96 can be 80% of the display area 80, 90% of the display area 80 or any suitable amount of the display area greater than 50%. Likewise, if the first portion 78 is 30%, the second portion 96 can be any suitable amount of the display area greater than 30%.

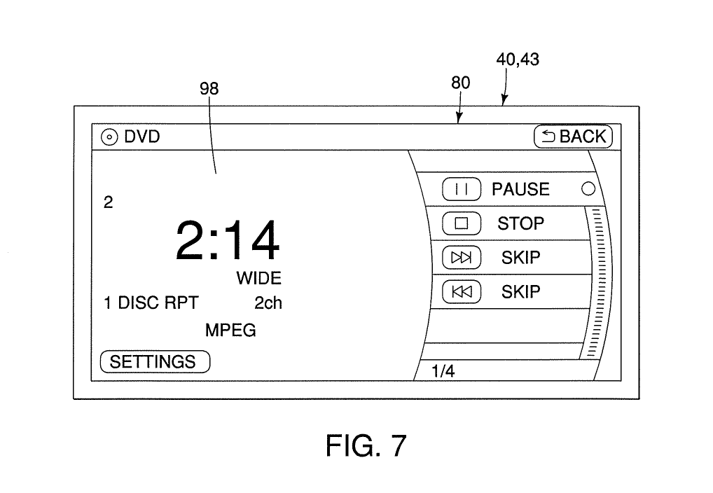

In step S150, the controller 38 determines whether the second vehicle condition has ceased. For example, when the driver shifts the transmission 68 from reverse to drive, the transmission sensor 68 can provide signals to the controller 38 indicating that the second vehicle condition no longer exists. Likewise, when the driver presses the button 72 to discontinue the type of monitoring discussed above, the button sensor 70 will indicate to the controller 38 that the second vehicle condition no longer exists. Also, the controller 38 can determine that the second vehicle condition no longer exists when a prescribed period of time has elapsed after the button 72 has been pressed. If the second vehicle condition has not ceased to occur, the controller 38 continues to control the display 40 and/or the display 43 to provide the monitoring information 94 on the greater portion 96 of the display area 80 in step S140. However, when the second sensor ceases to detect the second vehicle condition, or the prescribed time has elapsed, the controller 38 controls the display 40 and/or display 43 to discontinue providing the information 94 in step S160. Accordingly, the display 40 and/or display 43 can begin displaying information 98 pertaining to, for example, navigation, the entertainment system, and so on as shown in FIG. 7. Hence, as can be appreciated from the description herein, the vehicle monitoring system 12 provides a preview/notification mode to provide preview information well in advance of an operation of the vehicle 10, such as movement of the vehicle 10.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, any directional terms such as “forward”, “rearward”, “above”, “downward”, “vertical”, “horizontal”, “below” and “transverse” as well as any other similar directional terms refer to those directions of a vehicle equipped with the vehicle monitoring system. Accordingly, these terms, as utilized to describe the present invention should be interpreted relative to a vehicle equipped with the vehicle monitoring system. The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle monitoring system comprising:
a detection device coupled to a vehicle and configured to capture information relating to an area proximal to the vehicle;
a display including a display area configured to provide the information captured by the detection device to a user of the vehicle; and
a controller configured to control the display to provide the information on a first portion of the display area that is less than an entirety of the display area in response to a first vehicle condition and to provide the information on a second portion of the display area, greater than the first portion, in response to a second vehicle condition.

2. The vehicle monitoring system according to claim 1, wherein
the second portion is the entirety of the display area.

3. The vehicle monitoring system according to claim 1, wherein
the detection device includes a video camera configured to capture an image external to the vehicle as the information.

4. The vehicle monitoring system according to claim 1, wherein
the detection device includes a video camera configured to capture an image internal to the vehicle as the information.

5. The vehicle monitoring system according to claim 1, wherein
the detection device includes a proximity sensor configured to detect an object external to the vehicle and provide information pertaining to the detected object as the information.

6. The vehicle monitoring system according to claim 1, wherein
the first vehicle condition includes at least one of starting ignition of the vehicle, closing a door of the vehicle, sensing of a vehicle key within the vehicle, and depressing a brake or clutch pedal of the vehicle.

7. The vehicle monitoring system according to claim 1, wherein
the second vehicle condition includes at least one of shifting a transmission of the vehicle and pressing a button on the vehicle.

8. The vehicle monitoring system according to claim 1, wherein
the second vehicle condition occurs after the first vehicle condition.

9. The vehicle monitoring system according to claim 1, wherein
the first vehicle condition relates to a user's presence within the vehicle; and
the second vehicle condition relates to an operation of the vehicle.

10. The vehicle monitoring system according to claim 1, wherein
the controller is further configured to control the display to discontinue providing the information when the second vehicle condition ceases.

11. A vehicle monitoring method comprising:
capturing information relating to an area proximal to the vehicle; and
controlling a display having a display area to provide the information on a first portion of the display area that is less than an entirety of the display area in response to a first vehicle condition and to provide the information on a second portion of the display area, greater than the first portion, in response to a second vehicle condition.

12. The vehicle monitoring method according to claim 11, wherein
the second portion is the entirety of the display area.

13. The vehicle monitoring method according to claim 11, wherein
the capturing of information includes capturing an image external to the vehicle as the information.

14. The vehicle monitoring method according to claim 11, wherein
the capturing of information includes capturing an image internal to the vehicle as the information.

15. The vehicle monitoring method according to claim 11, wherein
the capturing of information includes detecting an object external to the vehicle and providing information pertaining to the detected object as the information.

16. The vehicle monitoring method according to claim 11, wherein
the first vehicle condition includes at least one of starting ignition of the vehicle, closing a door of the vehicle, sensing of a vehicle key within the vehicle, and depressing a brake or clutch pedal of the vehicle.

17. The vehicle monitoring method according to claim 11, wherein
the second vehicle condition includes at least one of shifting a transmission of the vehicle and pressing a button on the vehicle.

18. The vehicle monitoring method according to claim 11, wherein
the second vehicle condition occurs after the first vehicle condition.

19. The vehicle monitoring method according to claim 11, wherein
the first vehicle condition relates to a user's presence within the vehicle; and
the second vehicle condition relates to an operation of the vehicle.

20. The vehicle monitoring method according to claim 11, further comprising
controlling the display to discontinue providing the information when the second vehicle condition ceases.
